(19) United States
(12) Patent Application Publication
(10) Pub. No.: US 2026/0079046 A1
(43) Pub. Date: Mar. 19, 2026

(54) Spot Detection Control Method, Device, and Spot Detection System

(71) Applicant: Shenzhen Xinghan Laser Technology Co.,Ltd., Shenzhen (CN)

(72) Inventors: Shaofeng Zhou, Shenzhen (CN); Kaiyu Liang, Shenzhen (CN); Zhuhong Peng, Shenzhen (CN)

(73) Assignee: Shenzhen Xinghan Laser Technology Co.,Ltd., Shenzhen (CN)

(21) Appl. No.: 19/310,877

(22) Filed: Aug. 26, 2025

(30) Foreign Application Priority Data
Sep. 18, 2024 (CN) 202411300119.0

(51) Int. Cl. G01J 1/42

(52) U.S. Cl. CPC G01J 1/4257

(57) ABSTRACT

This application provides a spot detection control method, device, and spot detection system, which are applied to spot detection control equipment. First, according to the change information between the laser spot sizes corresponding to different positions on the main optical axis when the laser emitted by the laser is transmitted to these positions, the spot analyzer is controlled to move to the focal position on the main optical axis; then, the spot detection result of the laser is determined based on the first spot information collected by the spot analyzer at the focal position. The first spot information includes at least one of spot size, spot shape, and spot intensity data. This realizes the automatic real-time movement adjustment of the spot analyzer, ensures the accuracy of movement adjustment, improves the efficiency of moving the spot analyzer to the focal position, and thus enhances the detection efficiency of the detection result.

### RELATED APPLICATIONS

The present patent document claims the benefit of priority to Patent Application No. 202411300119.0, filed Sep. 18, 2024, and entitled “Spot Detection Control Method, Device, and Spot Detection System,” the entire content of which is incorporated herein by reference.

### BACKGROUND

### 1. Technical Field

This application relates to the field of laser technology, in particular to a spot detection control method, device, and spot detection system.

### 2. Background Information

The size of a laser spot is an important parameter reflecting the performance of a laser device. The energy emitted by the laser is mainly evaluated by detecting the size of the laser spot emitted by the laser. Among them, a laser focusing lens is used to focus the laser, and a spot analyzer is then used to detect the size of the focused laser spot. In related technologies, the position of the spot analyzer is adjusted based on the experience of testers to find a suitable detection position for spot size detection. However, the testing accuracy of this solution is affected by subjective judgments, resulting in low stability of spot detection.

### BRIEF SUMMARY

The present disclosure provides a spot detection control method, device, and spot detection system, aiming to solve the problem of low stability in spot detection.

A first aspect of the present disclosure provides a spot detection control method, including: controlling a spot analyzer to move to a focal position on the main optical axis according to the change information among the laser spot sizes corresponding to different positions on the main optical axis when the laser emitted by the laser device to be detected is transmitted to the different positions; determining the spot detection result of the laser device based on the first spot information collected by the spot analyzer at the focal position, wherein the first spot information includes at least one of spot size, spot shape, and spot intensity data.

In a possible implementation of the present application, controlling the spot analyzer to move to the focal position on the main optical axis according to the change information among the laser spot sizes corresponding to different positions on the main optical axis includes: controlling the detection head of the spot analyzer to move axially corresponding to the main optical axis, and obtaining the first spot size collected by the spot analyzer before movement and the second spot size re-collected by the spot analyzer after movement; determining target movement information for the next movement of the spot analyzer according to the change information between the first spot size and the second spot size; controlling the detection head of the spot analyzer to move axially corresponding to the main optical axis based on the target movement information until the re-collected spot size after movement is the smallest; taking the collection position corresponding to the smallest spot size as the focal position.

In a possible implementation of the present application, determining target movement information for the next movement of the spot analyzer according to the change information between the first spot size and the second spot size includes: determining the target movement axis of the detection head of the spot analyzer according to the size relationship between the first spot size and the second spot size, wherein the target movement axis is either the first axis or the second axis corresponding to the main optical axis, and the first axis is opposite to the second axis; determining the target movement amount according to the size difference between the first spot size and the second spot size; the target movement axis and the target movement amount are the target movement information.

In a possible implementation of the present application, determining the target movement axis of the detection head of the spot analyzer according to the size relationship between the first spot size and the second spot size includes: if the first spot size is less than or equal to the second spot size, and the movement axis of the previous movement is the first axis, determining the second axis as the target movement axis; if the first spot size is larger than the second spot size, determining the second axis as the target movement axis.

In a possible implementation of the present application, the step of determining the target movement amount according to the size difference between the first spot size and the second spot size includes: if the size difference between the first spot size and the second spot size is less than or equal to a preset size difference, taking half of the historical target movement amount corresponding to the previous movement as the target movement amount; if the size difference between the first spot size and the second spot size is larger than the preset size difference, determining the target movement amount according to the size difference.

In a possible implementation of the present application, before controlling the spot analyzer to move to the focal position on the main optical axis according to the change information among the laser spot sizes corresponding to different positions on the main optical axis, the method further includes: obtaining the focusing center position information corresponding to the laser focusing element in the laser device to be detected; determining the main optical axis position information of the laser focusing element according to the focusing center position information and the position information of the detection platform that carries the laser device to be detected; controlling the position adjustment of the detection head of the spot analyzer according to the main optical axis position information, so that the center point of the detection head of the spot analyzer is located on the main optical axis.

In a possible implementation of the present application, the first spot information includes spot size and spot intensity data; determining the spot detection result of the laser device based on the first spot information collected by the spot analyzer at the focal position includes: obtaining the spot size and spot intensity data collected by the spot analyzer at the focal position; If the spot size is the same as the standard reference spot size corresponding to the focal point of the laser device, and the spot intensity data falls within the standard intensity data range corresponding to the focal point of the laser device, determining that the spot detection result is qualified.

In a possible implementation of the present application, the method further includes: obtaining spot threshold information corresponding to the laser to be detected, where the spot threshold information includes at least one of a maximum spot size, a spot shape similarity threshold, and a maximum spot intensity range; controlling the detection head of the spot analyzer to move along the first axis starting from the focal position, and collecting second spot information in real time; controlling the detection head of the spot analyzer to move along the second axis starting from the focal position, and collecting third spot information in real time; determining the defocus error threshold of the laser device according to the matching degree between the second spot information, the third spot information, and the spot threshold information respectively.

A second aspect of the present disclosure provides a spot detection control device, including: one or more processors; a memory; and one or more application programs, where the one or more application programs are stored in the memory and configured to be executed by the processor to implement any of the above spot detection control methods.

A third aspect of the present disclosure provides a spot detection control system, including: a detection platform for carrying the laser to be detected; a spot analyzer; and the above-mentioned spot detection control device.

A fourth aspect of the present disclosure provides a computer-readable storage medium, on which a computer program is stored, and the computer program is loaded by a processor to execute the steps in any of the above spot detection control methods.

The spot detection control method, device, and spot detection system provided in the present application are applied to a spot detection control device. First, the spot analyzer is controlled to move to the focal position on the main optical axis according to the change information among the laser spot sizes corresponding to different positions on the main optical axis when the laser emitted by the laser device is transmitted to these positions; then, the spot detection result of the laser device is determined based on the first spot information collected by the spot analyzer at the focal position, where the first spot information includes at least one of spot size, spot shape, and spot intensity data. In this solution, while controlling the spot analyzer to move axially corresponding to the -emitting main optical axis of the laser, the spot sizes collected by the spot analyzer in real time are obtained, and the movement of the spot analyzer is controlled according to the change information between the real-time collected spot sizes until it moves to the focal position of the laser on the main optical axis. Furthermore, the spot detection result of the laser is determined based on the first spot information collected by the spot analyzer at the focal position. This abandons the traditional solution that relies on testers' experience for testing, realizes automatic real-time movement adjustment of the spot analyzer, ensures the accuracy of movement adjustment, improves the efficiency of moving the spot analyzer to the focal position, and thus enhances the detection efficiency of the detection result.

### BRIEF DESCRIPTION OF THE DRAWINGS

To clarify the technical solutions in the embodiments of the present application, the drawings required for describing the embodiments will be briefly introduced below. Obviously, the drawings in the following description are only some embodiments of the present invention, and those skilled in the art can obtain other drawings based on these drawings without creative work.

FIG. 1 is a schematic diagram of the scenario of the spot detection control method provided in the embodiment of the present application;

FIG. 2 is a flow diagram of an embodiment of the spot detection control method provided in the embodiment of the present application;

FIG. 3 is a flow diagram of one implementation scheme for controlling movement to the focal position in the spot detection control method provided in the present application;

FIG. 4 is a flow diagram of one implementation scheme for determining target movement information in the spot detection control method provided in the present application;

FIG. 5 is a flow diagram of another implementation scheme of the spot detection control method provided in the present application;

FIG. 6 is a flow diagram of another implementation scheme of the spot detection control method provided in the present application;

FIG. 7 is a structural diagram of an embodiment of the spot detection control device provided in the embodiment of the present application;

FIG. 8 is a structural diagram of an embodiment of the spot detection control equipment provided in the embodiment of the present application.

### DETAILED DESCRIPTION

The technical solutions in the embodiments of the present application will be clearly and completely described below in conjunction with the drawings in the embodiments of the present application. Obviously, the described embodiments are only a part of the embodiments of the present invention, rather than all the embodiments. Based on the embodiments in the present invention, all other embodiments obtained by those skilled in the art without creative work shall fall within the protection scope of the present invention.

In the description of the present invention, it should be understood that the terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer” indicate the orientation or positional relationship based on the orientation or positional relationship shown in the drawings, which are only for the convenience of describing the present invention and simplifying the description, rather than indicating or implying that the device or element referred to must have a specific orientation, be constructed and operated in a specific orientation, and thus cannot be understood as a limitation to the present invention. In addition, the terms “first” and “second” are only used for descriptive purposes, and cannot be understood as indicating or implying relative importance or implicitly indicating the quantity of the indicated technical features. Therefore, the features defined with “first” and “second” may explicitly or implicitly include one or more of the features. In the description of the present invention, “plurality” means two or more, unless otherwise clearly and specifically defined.

In the embodiments of this application, “and/or” describes the association relationship between related objects, indicating that there can be three types of relationships. For example, “A and/or B” can mean: A exists alone, both A and B exist simultaneously, or B exists alone. In addition, the character “/” generally indicates an “or” relationship between the associated objects before and after it, unless otherwise specified.

In this application, the word “exemplary” is used to mean “serving as an example, illustration or explanation”. Any embodiment described as “exemplary” in this application is not necessarily interpreted as being better than or superior to other embodiments. To enable any person skilled in the art to implement and use the present invention, the following description is provided. In the following description, details are set forth for the purpose of explanation. It should be understood that those of ordinary skill in the art can recognize that the present invention can be implemented without using these specific details. In other instances, well-known structures and processes are not described in detail to avoid obscuring the description of the present invention with unnecessary details. Therefore, the present invention is not intended to be limited to the embodiments shown, but is to be accorded the widest scope consistent with the principles and features disclosed in this application.

The embodiments of the present application provide a spot detection control method, device, equipment and computer-readable storage medium, which are described in detail below respectively.

The spot detection control method in the embodiment of the present invention is applied to a spot detection control device, which is provided with one or more processors, a memory, and one or more application programs, wherein one or more application programs are stored in the memory and configured to be executed by the processor to implement the spot detection control method; the spot detection control device can be a terminal, such as a mobile phone or a tablet computer, and can also be a server or a server cluster composed of multiple servers.

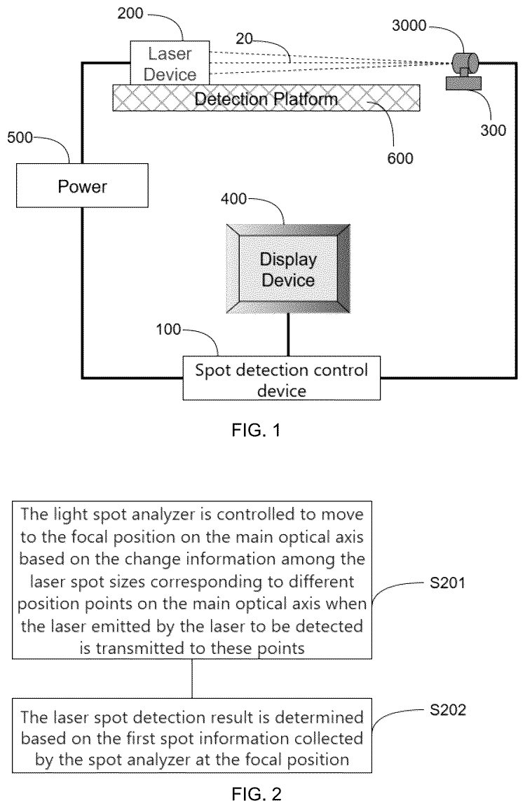

As shown in FIG. 1, it is a schematic diagram of the scenario of the spot detection control method in the embodiment of the present application. The spot detection control scenario in the embodiment of the present invention includes a spot detection control device 100 (the spot detection control function is integrated in the spot detection control device 100), and a computer-readable storage medium corresponding to spot detection control runs in the spot detection control device 100 to execute the steps of the spot detection control method.

It can be understood that the spot detection control device in the scenario of the spot detection control method shown in FIG. 1, or the devices included in the spot detection control device do not constitute a limitation to the embodiment of the present invention, that is, the number and type of devices included in the scenario of the spot detection control method, or the number and type of devices included in each device do not affect the overall implementation of the technical solution in the embodiment of the present invention, and all can be regarded as equivalent replacements or derivatives of the technical solution claimed in the embodiment of the present invention.

Referring to FIG. 1, in the scenario of the present application, there is also a laser device 200, which can be a blue laser device emitting a wavelength of 450-480 nm, or a red laser device emitting wavelengths of 610-730 nm and 647-760 nm, etc.

Specifically, the laser device 200 includes a laser device emitting element and a laser device focusing element, wherein the laser device focusing element is arranged at the laser emitting port of the laser emitting element, and is used for focusing the laser emitted by the laser emitting element and then emitting it from the laser emitting port, so that the emitted laser is focused on a certain focusing point on the main optical axis of the focusing element, so as to realize applications such as laser welding and laser etching.

Specifically, referring to FIG. 1, a main optical axis 20 of the laser focusing element is schematically shown in FIG. 1. It can be understood that the main optical axis 20 of the laser focusing element is generally located at the focusing center of the focusing element. For example, if the laser focusing element is a focusing lens, the straight line passing through the centers of the two spherical surfaces of the laser focusing lens is the main optical axis 20; it can be understood that the rays parallel to the main optical axis 20 is intersected at a point after passing through the laser focusing lens, and this intersection point is called the focal point, which is generally located on the main optical axis 20.

Referring to FIG. 1, in the scenario of the present application, there is also a spot analyzer 300, wherein the detection head 3000 of the spot analyzer 300 can move axially corresponding to the main optical axis to adjust the distance between the detection head 3000 and the laser emitting port of the laser, so as to realize focal point finding.

In the embodiment of the present invention, the spot detection control device 100 is mainly used for: controlling the spot analyzer to move to the focal position on the main optical axis according to the change information between the laser spot sizes corresponding to different position points when the laser emitted by the laser is transmitted to different position points on the main optical axis; determining the spot detection result of the laser according to the first spot information collected by the spot analyzer corresponding to the focal position, where the first spot information includes at least one of spot size, spot shape and spot intensity data.

The spot detection control device 100 in the embodiment of the present invention can be an independent spot detection control device, or a spot detection control device network or a spot detection control device cluster. For example, the spot detection control device 100 described in the embodiment of the present invention includes but is not limited to a computer, a network host, a single network spot detection control device, a set of multiple network spot detection control devices, or a cloud spot detection control device composed of multiple spot detection control devices. The cloud spot detection control device is composed of a large number of computers or network spot detection control devices based on cloud computing, or the spot detection device can be a control circuit board, etc.

Those skilled in the art can understand that the application environment shown in FIG. 1 is merely an application scenario related to the solution of the present application and does not constitute a limitation on the application scenarios of the present application. Other application environments may include more or fewer spot detection control devices 100, laser devices 200, and spot analyzers 300 than those shown in FIG. 1, or more network connection relationships among spot detection control devices 100, laser devices 200, and spot analyzers 300. For example, FIG. 1 only shows one spot detection control device 100, one laser device 200, and one spot analyzer 300. It can be understood that the scenario of the spot detection control method may also include one or more other spot detection control devices 100, multiple other laser devices 200, and multiple other spot analyzers 300, which are not specifically limited herein. The spot detection control device 100 may also include a memory for storing data, such as image information obtained by shooting, etc.

In this application scenario, the spot detection control device 100 may be provided with a display device, or the spot detection control device 100 may not be provided with a display device but communicate with an external display device 400, and the display device 400 is used to output the execution result of the spot detection control method in the spot detection control device. The spot detection control device 100 can access a background database (the background database can be in the local memory of the spot detection control device, and the background database can also be set in the cloud), and the background database stores information related to spot detection control.

In addition, a motion control board may also be provided in the spot detection control device 100, or connected with an external motion control board, so as to drive the movement of the spot analysis.

The scenario in this embodiment also includes a power supply 500 and a detection platform 600, wherein the power supply 500 is used to supply power to the spot detection control device 100, the laser device 200, the spot analyzer 300 and other devices; the detection platform 600 is used to carry the laser device 200 to be detected, and during application, the laser device 200 is placed at a preset position on the detection platform for fixing.

It should be noted that the schematic diagram of the scenario of the spot detection control method shown in FIG. 1 is only an example, and the scenario of the spot detection control method described in the embodiment of the present invention is to more clearly illustrate the technical solution of the embodiment of the present invention, and does not constitute a limitation to the technical solution provided by the embodiment of the present invention.

Based on the above scenario of the spot detection control method, an embodiment of the spot detection control method is proposed, wherein the spot detection control method in the solution of the present application is applied to a spot detection system, and the spot detection system includes a laser device and a spot analyzer.

As shown in FIG. 2, it is a flow diagram of an embodiment of the spot detection control method in the embodiment of the present application, and the spot detection control method includes steps S201-S202:

S201. Controlling the spot analyzer to move to the focal position on the main optical axis according to the change information among the laser spot sizes corresponding to different positions when the laser emitted by the laser device to be detected is transmitted to different positions on the main optical axis.

Wherein, the laser spot size can be parameters such as the length, width or area of the laser spot, which can be obtained by analyzing the spot image collected by the spot analyzer.

For example, by collecting the spot image at a certain position, the spot analyzer can analyze that the size parameters of the laser spot are: D % pkX1.41e+02 um; D % pkY1.19e+02 um; D % pk1.36e+02 um, etc., where D % pkX is the width of the laser spot, D % pkY is the height of the laser spot, and D % pk is a value obtained by preset calculation processing according to D % pkX and D % pkY.

Specifically, the laser device to be detected can be a blue laser device, a red laser device, etc.

Specifically, in the solution of the present application, the laser emitting element of the laser device emits laser, and the laser focusing element arranged at the laser output port of the laser device will focus the laser, and the focused is a laser beam that is gradually narrowed before the focal point. The cross-section of the laser beam transmitted to any position on the main optical axis is collected by the spot analyzer as the laser spot corresponding to that position. Further, the spot analyzer analyzes the collected laser spot image to obtain the laser spot size, and further combines the laser spot size of other positions collected by the spot analyzer in history to analyze the change information of the laser spot size, so as to determine the target movement information for the next movement of the spot analyzer, and cycle the movement until it moves to the focal position.

It can be understood that the main purpose of controlling the movement of the spot analyzer in the actual solution of the present application is to collect the laser spot sizes corresponding to different positions on the main optical axis, so controlling the movement of the spot analyzer is not limited to controlling the overall movement of the spot analyzer, and the detection head of the spot analyzer can also be controlled to move to achieve the purpose of collecting the laser spot sizes corresponding to different positions on the main optical axis.

The change information between the laser spot sizes corresponding to each position can be the size relationship among the laser spot sizes corresponding to each position, or the laser spot size variation or variation rate between the laser spot sizes corresponding to each position, etc.

It can be understood that the laser spot sizes of other positions collected in history are the laser spot sizes of other positions collected by the spot analyzer before the collection time of the currently obtained laser spot size when detecting the same laser. Specifically, the specific implementation scheme of determining the target movement information according to the change information among the laser spot sizes is not specifically limited in this application.

For example, in one of the implementation schemes of the present application, after controlling the spot analyzer to end the current movement, the spot size collected by the spot analyzer after the current movement is obtained, and the laser spot size collected by the spot analyzer after the end of the previous movement is obtained, and the target movement information for the next movement is determined according to the change information between the spot size collected after the current movement and the laser spot size collected after the end of the previous movement.

For example, in other implementation schemes of the present application, after controlling the spot analyzer to end the current movement, the spot size collected by the spot analyzer after the current movement is obtained, and the spot sizes collected by the spot analyzer after the end of all historical movements are obtained, the spot sizes are arranged according to the collection time sequence to obtain a spot size sequence, and the spot size sequence is input into a preset model to output the target movement information corresponding to the next movement. It can be understood that the preset model can be trained to have the function of predicting the target movement information corresponding to the next movement according to the input spot size sequence.

In the implementation scheme of the present application, the detection head of the spot analyzer can be aligned with the main optical axis of the laser emitted by the laser either manually or through automatic detection control.

S202. Determining the spot detection result of the laser according to the first spot information collected by the spot analyzer corresponding to the focal position.

Wherein, the first spot information includes at least one of spot size, spot shape and spot intensity data. Specifically, the spot intensity data can be spot intensity distribution, intensity average value, spot intensity total amount, etc., which is not specifically limited in this scheme.

Specifically, in one of the implementation schemes of the present application, the spot detection control method is applied to a spot detection control device. When the detection is initially started, the spot detection control device controls the spot analyzer to move so that the detection head of the spot detector is located on the main optical axis corresponding to the laser emitted by the laser device, and further controls the spot analyzer to move from the initial position along the main optical axis for the first movement according to the preset initial movement information, and further determines the target movement information for the next movement according to the change information between the laser spot sizes corresponding to each position before and after the movement, cycles the movement until the spot analyzer is controlled to move to the focal position on the main optical axis, and further obtains the first spot information of the focal position collected by the spot analyzer, compares the first spot information with the preset reference spot information corresponding to the laser to be detected, judges whether the first spot information meets the standard, and then obtains the spot detection result of the laser device.

Specifically, the preset initial movement information can be general movement information or movement information corresponding to the type of the laser device to be detected.

In some implementation schemes of the present application, the spot detection control device identifies the category of the laser device to be detected. For example, the spot detection control device collects the image of the laser device of the laser device to be detected, identifies according to the laser image, determines the category of the laser to be detected, and obtains the initial movement information corresponding to the category stored in the database according to the category.

Specifically, the category of the laser can be divided according to the similarity of the focal position, and type-associated storage is performed by identifying the model information of the type of the laser device. That is, by identifying the model information of the laser device in the image of the laser device, the category of the laser device to be detected can be identified according to the model information.

It can be understood that the model information of the laser device represents the product classification of the laser device. For example, multiple identical lasers have the same model information, while the above-mentioned categories are divided according to the similarity of the focal position in the implementation process of the spot detection control method, which are different concepts.

For example, laser devices whose focal positions are located in a preset position area can be divided into the same category, and the association relationship between the category and the model information of each laser device is created. By looking up the association relationship, the category of the laser device to be detected can be identified according to the model information. At the same time, it can be understood that the initial movement information can be determined according to the position correspondence between the preset position area and the initial position of the detection head of the spot analyzer. For example, the initial movement direction is determined according to the relative position between the preset position area and the initial position of the detection head of the spot analyzer, the distance between any position in the preset position area and the initial position of the detection head is taken as the initial movement amount, and the initial movement direction and the initial movement amount are taken as the initial movement information.

Specifically, in the solution of the present application, the spot detection control device updates the database in real time according to the detection information, and the database can be a cloud database or a local database, which is not specifically limited.

For example, after the spot detection control device identifies the model information of the laser to be detected, if the corresponding category is not found in the database, it starts the movement stroke according to the general initial movement information. After completing the spot detection of the laser device to be detected and obtaining the focal position, it determines the category of the laser device to be detected according to the focal position, stores the model information of the laser device to be detected in the database, and establishes an association relationship between the model information of the laser device to be detected and the corresponding category.

Specifically, in the implementation scheme of the present application, the spot detection control device controls the spot analyzer to move axially corresponding to the -emitting main optical axis of the laser device, and at the same time, obtains the spot sizes collected by the spot analyzer in real time, and controls the movement of the spot analyzer according to the change information between the real-time collected spot sizes until it moves to the focal position of the laser emitted by the laser on the main optical axis, and further determines the spot detection result of the laser device according to the first spot information collected by the spot analyzer corresponding to the focal position, abandoning the traditional scheme that relies on the experience of testers for testing, realizing the automatic real-time movement adjustment of the spot analyzer, ensuring the accuracy of movement adjustment, improving the efficiency of moving the spot analyzer to the focal position, and thus improving the detection efficiency of the detection result.

By classifying categories according to focal positions, a database is created for searching initial movement information, enabling lasers to be detected of different categories to quickly determine the possible area where the focal position lies. Moreover, the detection head is controlled to reach this area according to the initial movement information for focal position searching, so as to lock the focal area in advance, reduce the movement stroke, and further improve the efficiency and accuracy of stroke movement.

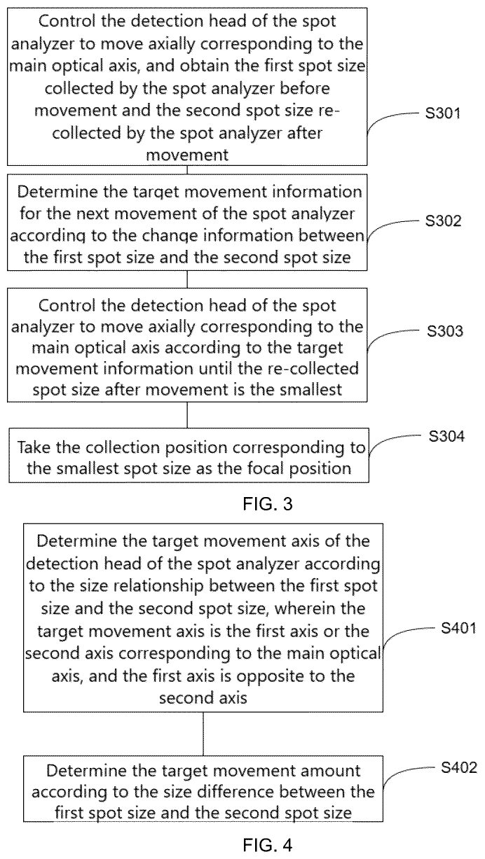

Further, on the basis of any of the above implementation schemes, the present application also provides an implementation scheme for controlling movement to the focal position. As shown in FIG. 3, FIG. 3 is a flow diagram of one of the implementation schemes for controlling movement to the focal position in the spot detection control method provided by the present application, which specifically includes steps S301-S304:

S301. controlling the detection head of the spot analyzer to move axially corresponding to the main optical axis, and obtain the first spot size collected by the spot analyzer before movement and the second spot size re-collected by the spot analyzer after movement.

S302. determining the target movement information for the next movement of the spot analyzer according to the change information between the first spot size and the second spot size.

S303. controlling the detection head of the spot analyzer to move axially corresponding to the main optical axis according to the target movement information until the re-collected spot size after movement is the smallest.

S304. taking the collection position corresponding to the smallest spot size as the focal position.

Specifically, in the implementation scheme of the present application, when the spot detection control device controls the spot analyzer to perform the first movement, it first controls the spot analyzer to collect the first spot size before movement, further controls the spot analyzer to complete the first detection stroke according to the initial movement information, controls the spot analyzer to collect the second spot size at the current position, then analyzes the change information between the first spot size and the second spot size through a pre-designed calculation formula, a preset model, etc., determines the target movement information for the next corresponding to the change information, controls the detection head of the spot analyzer to move axially corresponding to the main optical axis according to the target movement information, and after completing the movement, controls the spot analyzer to re-collect a new target stroke as the second spot size, and takes the second spot size collected after the end of the previous movement as the first spot size, re-determines the target movement information for the next movement according to the re-determined first spot size and second spot size, repeats the cycle process, arranges the spot sizes collected corresponding to each movement stroke (including the first spot size and the second spot size) according to the collection time, and if the change rule of the arranged spot sizes is that they become smaller gradually and then larger gradually, takes the collection position corresponding to the smallest spot size among the spot sizes as the focal position, and controls the detection head of the spot analyzer to move to the focal position.

Further, on the basis of any of the above implementation schemes, the present application also provides an implementation scheme for determining target movement information. As shown in FIG. 4, FIG. 4 is a flow diagram of one of the implementation schemes for determining target movement information in the spot detection control method provided by the present application, which specifically includes steps S401-S402:

S401. determining the target movement axis of the detection head of the spot analyzer according to the size relationship between the first spot size and the second spot size, where the target movement axis is the first axis or the second axis corresponding to the main optical axis, and the first axis is opposite to the second axis.

Wherein, the main optical axis includes two opposite axes, one of which is the direction moving towards the laser to be detected along the main optical axis, and the other is the direction moving away from the laser to be detected along the main optical axis.

It can be understood that the first axis can be the axis corresponding to the direction moving towards the laser to be detected, or the axis corresponding to the direction moving away from the laser to be detected, which is not specifically limited in this application.

Specifically, in the implementation scheme of the present application, the step of determining the target movement axis of the detection head of the spot analyzer according to the size relationship between the first spot size and the second spot size specifically includes:
(1) If the first spot size is less than or equal to the second spot size, and the movement axis of the previous movement is the first axis, determining the second axis as the target movement axis;
(2) If the first spot size is larger than the second spot size, determining the second axis as the target movement axis.

Specifically, if the first spot size is smaller than the second spot size, it indicates that the spot becomes larger gradually when moving along the first axis, and then it is necessary to control the spot analyzer to move in the opposite direction of the first axis, and take the second axis opposite to the first axis as the target movement axis.

Specifically, if the first spot size is equal to the second spot size, it indicates that the spot after moving along the first axis is as large as that before moving, and then the focal position is the middle position of the ended movement, and it is necessary to control the spot analyzer to move in the opposite direction of the first axis, and take the second axis opposite to the first axis as the target movement axis.

It can be understood that if the size difference between the first spot size and the second spot size is less than or equal to the preset size difference, it can be determined that the first spot size is equal to the second spot size, so as to ensure the adjustment flexibility.

Specifically, if the first spot size is larger than the second spot size, it indicates that the spot becomes smaller gradually when moving along the first axis, and then it is necessary to control the spot analyzer to continue moving along the first axis, and take the first axis as the target movement axis.

S402. determining the target movement amount according to the size difference between the first spot size and the second spot size.

Specifically, in the implementation scheme of the present application, after obtaining the first spot size and the second spot size, the spot detection control device calculates the size difference between the first spot size and the second spot size, looks up the preset mapping relationship between the difference and the movement information, and obtains the target movement amount corresponding to the size difference; or inputs the size difference into a preset prediction model to predict the target movement amount corresponding to the size difference, which is not specifically limited in this application, and the prediction model can have this function through training.

Specifically, in the implementation scheme of the present application, after obtaining the target movement amount and the target movement direction, the target movement axis and the target movement amount are taken as the target movement information.

Specifically, in the implementation scheme of the present application, the step of determining the target movement amount according to the size difference between the first spot size and the second spot size specifically includes:
(1) If the size difference between the first spot size and the second spot size is less than or equal to the preset size difference, taking half of the historical target movement amount corresponding to the previous movement as the target movement amount;
(2) If the size difference between the first spot size and the second spot size is larger than the preset size difference, determining the target movement amount according to the size difference.

Specifically, in one of the implementation schemes of the present application, after obtaining the first spot size and the second spot size, the spot detection control device calculates the size difference between the first spot size and the second spot size, looks up the preset mapping relationship between the difference and the movement information, and obtains the target movement amount corresponding to the size difference.

Specifically, in the implementation scheme of the present application, the database also includes a preset mapping relationship between the difference and the movement information, which can be a general mapping relationship, or a preset mapping relationship set for each category to ensure the adjustment progress. The mapping relationship includes multiple mapping groups, and each mapping group includes a size difference and a movement amount corresponding to the difference.

It can be understood that if the preset mapping relationship is a preset mapping relationship set for each category, the category of the laser to be detected is first identified and determined, and then the preset mapping relationship corresponding to the category is obtained, and the target movement amount corresponding to the size difference is determined by looking up the mapping relationship.

Specifically, in one of the implementation schemes of the present application, the size difference is proportional to the target movement amount, that is, it follows the change rule that the larger the size difference, the larger the target movement amount, so as to ensure the accuracy of finding the focal position.

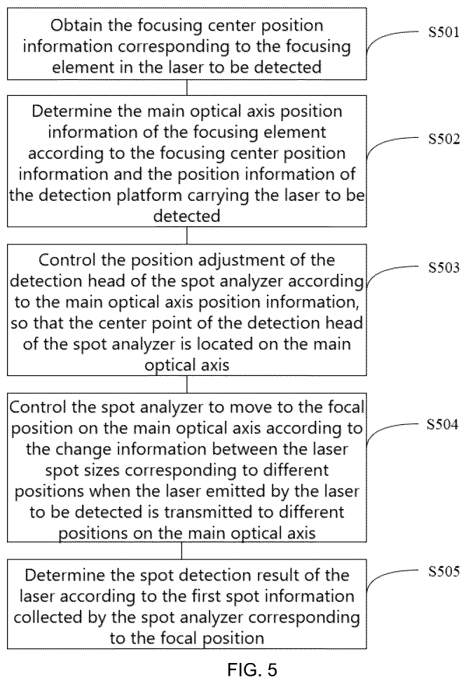

Further, on the basis of any of the above implementation schemes, the present application also provides another implementation scheme of the spot detection control method, specifically as shown in FIG. 5, FIG. 5 is a flow diagram of another implementation scheme of the spot detection control method provided by the present application, which specifically includes steps S501-S505:

S501. obtaining the focusing center position information corresponding to the laser focusing element in the laser to be detected.

In one of the implementation schemes of the present application, the model information of the laser to be detected is obtained, and the model information includes the height and width of the focusing center of the laser focusing element as the focusing center position information.

In another implementation scheme of the present application, the image information of the -emitting surface of the laser to be detected can also be collected, the center position coordinates of the laser focusing element are identified according to the image information, the coordinates are converted into the actual height and width of the focusing center as the focusing center position information, or the center position coordinates are directly taken as the focusing center position information.

S502. determining the main optical axis position information of the laser focusing element according to the focusing center position information and the position information of the detection platform carrying the laser to be detected;

Specifically, in the implementation scheme of the present application, the spot detection control device constructs a coordinate system corresponding to the preset installation area of the detection platform as the basis for the movement control of the spot analyzer, and calibrates the spot analyzer into the coordinate system to ensure that the spot analyzer can be controlled to move according to the coordinate information.

Specifically, after obtaining the focusing center position information, the spot detection control device maps the focusing center position information into the coordinate system to obtain the focusing center coordinates, and further extends the focusing center coordinates along the direction of the main optical axis to obtain the main optical axis position information described by multiple three-dimensional coordinate points.

S503. controlling the position adjustment of the detection head of the spot analyzer according to the main optical axis position information, so that the center point of the detection head of the spot analyzer is located on the main optical axis.

For example, if the direction of the main optical axis is the Z-axis direction, the width of the focusing center coordinates is represented by X-axis data, and the height is represented by Y-axis data, then the X and Y axis positions in the main optical axis position information remain unchanged.

That is, it can be understood that before starting the movement of controlling the first axial movement, the detection head of the spot analyzer is first moved from the calibration position (the calibration position is the initial three-dimensional coordinate point) to the coordinate point corresponding to the X and Y points, so as to realize the function of controlling the position adjustment of the detection head of the spot analyzer so that the center point of the detection head of the spot analyzer is located on the main optical axis, that is, the adjusted point is the initial position in the above implementation scheme.

S504. controlling the spot analyzer to move to the focal position on the main optical axis according to the change information between the laser spot sizes corresponding to different positions when the laser emitted by the laser to be detected is transmitted to different positions on the main optical axis.

S505. determining the spot detection result of the laser according to the first spot information collected by the spot analyzer corresponding to the focal position.

Wherein, the first spot information includes at least one of spot size, spot shape and spot intensity data.

Specifically, the specific implementation manner of steps S401-S405 is as shown in any of the above implementation schemes.

This scheme realizes the automatic adjustment of the center point of the detection head of the spot analyzer to be located on the main optical axis, and improves the efficiency of spot detection control while realizing automatic spot detection.

Further, on the basis of any of the above implementation schemes, the present application also provides an implementation scheme for confirming the spot detection result. Specifically, in the implementation scheme of the present application, when controlling the spot analyzer to move to the focal position, the spot detection control device controls the spot analyzer to collect the first spot information at the focal position, and compares the first spot information with the standard spot information corresponding to the focal point of the laser to be detected to judge whether the laser to be detected meets the laser output requirements.

For example, in one of the implementation schemes of the present application, the first spot information includes spot size and spot intensity data, and the step of determining the spot detection result of the laser according to the first spot information collected by the spot analyzer corresponding to the focal position specifically includes:
(1) Obtaining the spot size and spot intensity data collected by the spot analyzer corresponding to the focal position;
(2) If the spot size is the same as the standard reference spot size corresponding to the focal point of the laser, and the spot intensity data belongs to the standard intensity data range corresponding to the focal point of the laser, determining that the spot detection result is qualified.

It can be understood that the spot size in this scheme being the same as the standard reference spot size corresponding to the focal point of the laser is not limited to being substantially the same, and it can also be determined as the same when the error is less than the preset error threshold.

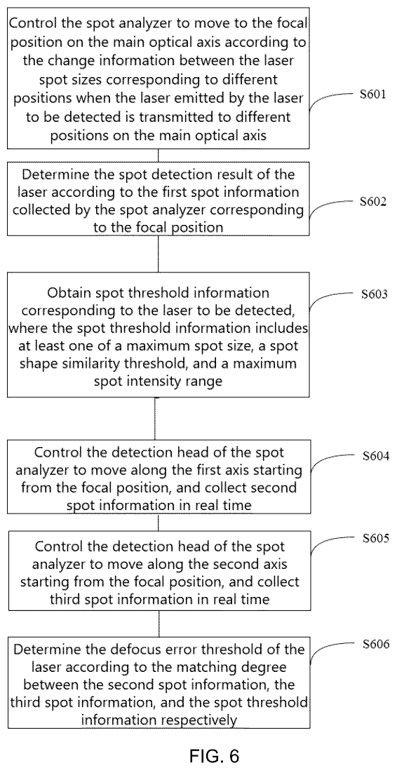

Further, on the basis of any of the above implementation schemes, the present application also provides another implementation scheme of the spot detection control method, specifically as shown in FIG. 6, FIG. 6 is a flow diagram of another implementation scheme of the spot detection control method provided by the present application, which specifically includes steps S601-S606:

S601. controlling the spot analyzer to move to the focal position on the main optical axis according to the change information between the laser spot sizes corresponding to different positions when the laser emitted by the laser to be detected is transmitted to different positions on the main optical axis.

S602. determining the spot detection result of the laser according to the first spot information collected by the spot analyzer corresponding to the focal position.

Wherein, the first spot information includes at least one of spot size, spot shape similarity and spot intensity data.

Specifically, the specific implementation scheme of steps S601-S602 is as described in any of the above implementation schemes.

S603. obtaining spot threshold information corresponding to the laser to be detected, where the spot threshold information includes at least one of a maximum spot size, a spot shape similarity threshold, and a maximum spot intensity range.

S604. controlling the detection head of the spot analyzer to move along the first axis starting from the focal position, and collect second spot information in real time.

S605. controlling the detection head of the spot analyzer to move along the second axis starting from the focal position, and collect third spot information in real time.

S606. determining the defocus error threshold of the laser according to the matching degree between the second spot information, the third spot information and the spot threshold information respectively.

Specifically, in the implementation scheme of the present application, the second spot information, the third spot information and the spot threshold information contain the same types of information. Among them, the maximum spot size, the spot shape similarity threshold and the maximum spot intensity range are three different types of information respectively, and the second spot information and the third spot information respectively include spot size, spot shape similarity and spot intensity corresponding to different types.

Specifically, in the implementation scheme of the present application, the spot detection control device controls the detection head of the spot analyzer to move along the first axis according to the preset movement distance, obtains one piece of second spot information each time it moves, compares the obtained second spot information with the spot threshold information, and if the data of at least one information type reaches the threshold, takes the distance between the position point where the second spot information is collected and the focal position as the defocus error threshold of the first axis. Similarly, the defocus error threshold corresponding to the second axis is determined according to the third spot information.

For example, the size information in the second spot information reaches the maximum spot threshold, the spot shape similarity reaches the spot shape similarity threshold, or the spot intensity data reaches the maximum or minimum value in the maximum spot intensity range, then the data of at least one information type reaches the threshold.

It can be understood that the laser emission capability of the laser device assembled with the laser can be detected to meet the standard according to the defocus error threshold of the first axis and the defocus error threshold of the second axis.

The spot detection control method provided by the embodiment of the present application controls the spot analyzer to move axially corresponding to the -emitting main optical axis of the laser, and at the same time, obtains the spot sizes collected by the spot analyzer in real time, and controls the movement of the spot analyzer according to the change information between the real-time collected spot sizes until it moves to the focal position of the laser emitted by the laser on the main optical axis, and further determines the spot detection result of the laser according to the first spot information collected by the spot analyzer corresponding to the focal position, abandoning the traditional scheme that relies on the experience of testers for testing, realizing the automatic real-time movement adjustment of the spot analyzer, ensuring the accuracy of movement adjustment, improving the efficiency of moving the spot analyzer to the focal position, and thus improving the detection efficiency of the detection result.

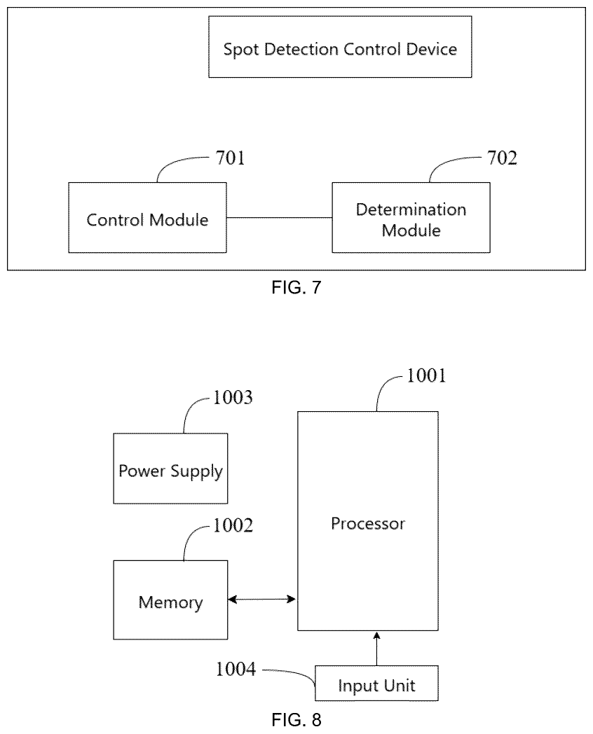

To better implement the spot detection control method in the embodiments of the present application, based on the spot detection control method, an embodiment of the present application further provides a spot detection control device. As shown in FIG. 7, the spot detection control device includes modules 701-702:

Control Module 701: configured to control the spot analyzer to move to the focal position on the main optical axis according to the change information between the laser spot sizes corresponding to different positions on the main optical axis when the laser emitted by the laser to be detected is transmitted to these positions.

Determination Module 702: configured to determine the spot detection result of the laser based on the first spot information collected by the spot analyzer at the focal position, where the first spot information includes at least one of spot size, spot shape, and spot intensity data.

Further, in other embodiments of the present application, a spot detection control device is provided. The device integrates the spot detection control functionality described in the embodiments of the present invention and includes: one or more processors; memory; one or more application programs, stored in the memory and configured to be executed by the processor to perform the steps of the spot detection control method described in any of the above embodiments.

It is understood that in other implementations, the spot detection control device may also have an independent structure, wherein the processor and memory are separately provided as components of the device.

As shown in FIG. 8, which is a schematic structural diagram of an embodiment of the spot detection control device provided in the present application.

Specifically: The spot detection control device may include components such as a processor 1001 with one or more processing cores, a memory 1002 with one or more computer-readable storage media, a power supply 1003, and an input unit 1004. Those skilled in the art can understand that the structure of the spot detection control device shown in FIG. 8 does not constitute a limitation on the spot detection control device, and may include more or fewer components than those shown, or combine some components, or have different component arrangements.

Wherein:

Processor 1001: a processing core with one or more cores, serving as the control center that connects various components of the device through interfaces and buses. It executes software programs and modules stored in the memory 1002 to perform various functions and process data, thereby monitoring the entire device. Optionally, the processor 1001 may include one or more processing cores and may integrate an application processor and a modem processor. The application processor handles the operating system, user interface, and applications, while the modem processor handles wireless communication. However, the modem processor may not be integrated into the processor 1001.

Memory 1002: used to store software programs and modules. The processor 1001 executes these programs and modules to perform various functional applications and data processing. The memory 1002 mainly includes a program storage area and a data storage area. The program storage area may store an operating system, application programs required for at least one function (such as sound playback, image playback), etc. The data storage area may store data created based on the use of the spot detection control device. Additionally, the memory 1002 may include high-speed random access memory and non-volatile memory, such as at least one magnetic disk storage device, flash memory device, or other volatile solid-state storage devices. Correspondingly, the memory 1002 may also include a memory controller to provide the processor 1001 with access to the memory 1002.

In some embodiments of the present application, the spot detection control device can be implemented in the form of a computer program, and the computer program can run on the spot detection control device as shown in FIG. 8. The memory of the spot detection control device can store various program modules that constitute the spot detection control device, such as the control module 701 and the determination module 702 shown in FIG. 7. The computer program composed of each program module enables the processor to execute the steps in the spot detection control method described in each embodiment of the present specification.

For example, the spot detection control device shown in FIG. 8 can execute step S201 of the spot detection control method in this application through the control module 701 in the spot detection control device shown in FIG. 7, and execute step S202 of the spot detection control method in this application through the determination module 702. The spot detection control device includes a processor, a memory, and a network interface connected via a system bus. Among them, the processor of the spot detection control device is used to provide computing and control capabilities. The memory of the spot detection control device includes a non-volatile storage medium and an internal memory. The non-volatile storage medium stores an operating system and a computer program. The internal memory provides an environment for the operation of the operating system and the computer program in the non-volatile storage medium. The network interface of the spot detection control device is used for communicating with external spot detection control devices through a network connection. When the computer program is executed by the processor, it implements a spot detection control method.

The spot detection control device also includes a power supply 1003 for supplying power to various components. Preferably, the power supply 1003 can be logically connected to the processor 1001 through a power management system, so that functions such as charging, discharging, and power consumption management can be realized through the power management system. The power supply 1003 can also include any components such as one or more DC or AC power sources, recharging systems, power failure detection circuits, power converters or inverters, and power status indicators.

The spot detection control device may further include an input unit 1004, which can be used to receive input digital or character information, and generate keyboard, mouse, joystick, optical or trackball signal inputs related to user settings and function control.

Although not shown, the spot detection control device may also include a display unit, etc., which will not be described in detail here. In this embodiment, the processor 1001 of the spot detection control device loads executable files corresponding to the processes of one or more application programs into the memory 1002 according to the following instructions and runs the application programs stored in the memory 1002 to implement the following functions:

Control the spot analyzer to move to the focal position on the main optical axis according to the change information between the laser spot sizes corresponding to different positions on the main optical axis when the laser emitted by the laser to be detected is transmitted to these positions.

Determine the spot detection result of the laser based on the first spot information collected by the spot analyzer at the focal position, where the first spot information includes at least one of spot size, spot shape, and spot intensity data.

A person of ordinary skill in the art understands that all or part of the steps in the various methods of the above embodiments may be completed by instructions or by controlling relevant hardware with instructions. These instructions may be stored in a computer-readable storage medium and loaded and executed by a processor.

Therefore, an embodiment of the present invention provides a computer-readable storage medium, which may include a read-only memory (ROM), a random access memory (RAM), a magnetic disk, or an optical disc. A computer program stored thereon is loaded by a processor to perform the steps of any of the spot detection control methods provided in the embodiments of the present invention. For example, the computer program, when loaded by the processor, may perform the following steps:

Control the spot analyzer to move to the focal position on the main optical axis according to the change information between the laser spot sizes corresponding to different positions on the main optical axis when the laser emitted by the laser to be detected is transmitted to these positions.

Determine the spot detection result of the laser based on the first spot information collected by the spot analyzer at the focal position, where the first spot information includes at least one of spot size, spot shape, and spot intensity data.

The present application further provides an embodiment of a spot detection system, which specifically includes: a detection platform for carrying the laser to be detected; a spot analyzer; the spot detection control device described in any of the above embodiments.

In the above embodiments, the description of each embodiment has its own emphasis. For parts not described in detail in a certain embodiment, reference may be made to the detailed descriptions of other embodiments above, and details are not repeated here.

During specific implementation, the above units or structures may be implemented as independent entities or combined in any manner as the same or several entities. For the specific implementation of the above units or structures, reference may be made to the previous method embodiments, and details are not repeated here.

The specific implementation of each of the above operations may refer to the previous embodiments, and details are not repeated here.

The above describes in detail a spot detection control method, device, and spot detection system provided in the embodiments of the present application. Specific examples are used herein to explain the principles and implementation methods of the present invention. The descriptions of the above embodiments are only used to help understand the method of the present invention and its core ideas.

At the same time, for those skilled in the art, according to the ideas of the present invention, there will be changes in the specific implementation manner and application scope. In summary, the content of this specification should not be construed as a limitation to the present invention.

1. A spot detection control method, comprising:
controlling a spot analyzer to move to a focal position on the main optical axis according to the change information among the laser spot sizes corresponding to different positions on the main optical axis when the laser emitted by the laser device to be detected is transmitted to the different positions;
determining the spot detection result of the laser device based on the first spot information collected by the spot analyzer at the focal position, wherein the first spot information comprises at least one of spot size, spot shape, and spot intensity data;
obtaining the spot threshold information corresponding to the laser to be detected, wherein the spot threshold information comprises at least one of the maximum spot size, spot shape similarity threshold, and maximum spot intensity range;
controlling the detection head of the spot analyzer to move along the first axis starting from the focal point, and collecting the second spot information in real-time;
controlling the detection head of the spot analyzer to move along the second axis starting from the focal point, and collecting the third spot information in real-time;
determining the defocus error threshold of the laser based on the matching degree between the second spot information, the third spot information, and the spot threshold information respectively;
wherein the step of controlling the spot analyzer to move to the focal position on the main optical axis according to the change information between the laser spot sizes corresponding to each position point when the laser emitted by the laser to be detected is transmitted to different position points on the main optical axis comprises:
controlling the detection head of the spot analyzer to move axially corresponding to the main optical axis, and obtain the first spot size collected by the spot analyzer before the movement and the second spot size re-collected by the spot analyzer after the movement;
determining the target movement information of the next movement stroke of the spot analyzer according to the change information between the first spot size and the second spot size;
controlling the optical detection head of the spot analyzer to move axially corresponding to the main optical axis according to the target movement information until the spot size re-collected after the movement is the smallest;
taking the collection position corresponding to the smallest spot size as the focal position;
the step of determining the target movement information of the next movement stroke of the spot analyzer according to the change information between the first spot size and the second spot size comprising:
determining the target movement axis of the detection head of the spot analyzer according to the size relationship between the first spot size and the second spot size, where the target movement axis is the first axis or the second axis corresponding to the main optical axis, and the first axis and the second axis are opposite; and
determining the target movement amount according to the size difference between the first spot size and the second spot size;
wherein the target movement axis and the target movement amount are the target movement information;
wherein the step of determining the target movement amount according to the size difference between the first spot size and the second spot size comprising:
if the size difference between the first spot size and the second spot size is less than or equal to the preset size difference, taking half of the historical target movement amount corresponding to the previous movement stroke as the target movement amount;
if the size difference between the first spot size and the second spot size is greater than the preset size difference, determining the target movement amount according to the size difference;
wherein before the step of controlling the spot analyzer to move to the focal position on the main optical axis according to the change information between the laser spot sizes corresponding to each position point when the laser emitted by the laser to be detected is transmitted to different position points on the main optical axis, the method further comprises:
obtaining the focusing center position information corresponding to the laser focusing element in the laser to be detected;
determining the main optical axis position information of the laser focusing element according to the focusing center position information and the position information of the detection platform that carries the laser to be detected; and
controlling the position adjustment of the detection head of the spot analyzer according to the main optical axis position information, so that the center point of the detection head of the spot analyzer is located on the main optical axis.

2. The spot detection control method according to claim 1, wherein determining the target movement axis of the detection head of the spot analyzer according to the size relationship between the first spot size and the second spot size comprises:
if the first spot size is less than or equal to the second spot size, and the movement axis of the previous movement is the first axis, determining the second axis as the target movement axis; and
if the first spot size is larger than the second spot size, determining the second axis as the target movement axis.

3. The spot detection control method according to claim 1, wherein the first spot information comprises spot size and spot intensity data; and
Wherein determining the spot detection result of the laser device based on the first spot information collected by the spot analyzer corresponding to the focal position comprises:
obtaining the spot size and spot intensity data collected by the spot analyzer corresponding to the focal position; and
if the spot size is the same as the standard reference spot size corresponding to the focal point of the laser device, and the spot intensity data falls within the standard intensity data range corresponding to the focal point of the laser device, determining that the spot detection result is qualified.

4. The spot detection control method according to claim 1, further comprising:
obtaining spot threshold information corresponding to the laser to be detected, wherein the spot threshold information comprises at least one of a maximum spot size, a spot shape similarity threshold, and a maximum spot intensity range;
controlling the detection head of the spot analyzer to move along the first axis starting from the focal position, and collecting second spot information in real time;
controlling the detection head of the spot analyzer to move along the second axis starting from the focal position, and collecting third spot information in real time; and
determining the defocus error threshold of the laser according to the matching degree between the second spot information, the third spot information, and the spot threshold information respectively.

5. The spot detection control method according to claim 2, further comprising:
obtaining spot threshold information corresponding to the laser to be detected, where the spot threshold information comprises at least one of a maximum spot size, a spot shape similarity threshold, and a maximum spot intensity range;
controlling the detection head of the spot analyzer to move along the first axis starting from the focal position, and collecting second spot information in real time;
controlling the detection head of the spot analyzer to move along the second axis starting from the focal position, and collecting third spot information in real time; and
determining the defocus error threshold of the laser according to the matching degree between the second spot information, the third spot information, and the spot threshold information respectively.

6. The spot detection control method according to claim 3, further comprising:
obtaining spot threshold information corresponding to the laser to be detected, where the spot threshold information comprises at least one of a maximum spot size, a spot shape similarity threshold, and a maximum spot intensity range;
controlling the detection head of the spot analyzer to move along the first axis starting from the focal position, and collecting second spot information in real time;
controlling the detection head of the spot analyzer to move along the second axis starting from the focal position, and collecting third spot information in real time; and
determining the defocus error threshold of the laser according to the matching degree between the second spot information, the third spot information, and the spot threshold information respectively.

7. A spot detection control device, comprising:
a module for controlling a spot analyzer to move to a focal position on the main optical axis according to the change information among the laser spot sizes corresponding to different positions on the main optical axis when the laser emitted by the laser device to be detected is transmitted to the different positions;
a module for determining the spot detection result of the laser device based on the first spot information collected by the spot analyzer at the focal position, wherein the first spot information comprises at least one of spot size, spot shape, and spot intensity data;
a module for obtaining the spot threshold information corresponding to the laser to be detected, wherein the spot threshold information comprises at least one of the maximum spot size, spot shape similarity threshold, and maximum spot intensity range;
a module for controlling the detection head of the spot analyzer to move along the first axis starting from the focal point, and collecting the second spot information in real-time;
a module for controlling the detection head of the spot analyzer to move along the second axis starting from the focal point, and collecting the third spot information in real-time;
a module for determining the defocus error threshold of the laser based on the matching degree between the second spot information, the third spot information, and the spot threshold information respectively;
wherein the module for controlling the spot analyzer to move to the focal position on the main optical axis according to the change information between the laser spot sizes corresponding to each position point when the laser emitted by the laser to be detected is transmitted to different position points on the main optical axis comprises:
a sub-module for controlling the detection head of the spot analyzer to move axially corresponding to the main optical axis, and obtain the first spot size collected by the spot analyzer before the movement and the second spot size re-collected by the spot analyzer after the movement;
a sub-module for determining the target movement information of the next movement stroke of the spot analyzer according to the change information between the first spot size and the second spot size;
a sub-module for controlling the optical detection head of the spot analyzer to move axially corresponding to the main optical axis according to the target movement information until the spot size re-collected after the movement is the smallest;
a sub-module for taking the collection position corresponding to the smallest spot size as the focal position;
wherein the module for determining the target movement information of the next movement stroke of the spot analyzer according to the change information between the first spot size and the second spot size comprises:
a sub-module for determining the target movement axis of the detection head of the spot analyzer according to the size relationship between the first spot size and the second spot size, wherein the target movement axis is the first axis or the second axis corresponding to the main optical axis, and the first axis and the second axis are opposite;
a sub-module for determining the target movement amount according to the size difference between the first spot size and the second spot size;
wherein target movement axis and the target movement amount are the target movement information;
wherein the module for determining the target movement amount according to the size difference between the first spot size and the second spot size comprises:
a sub-module for taking half of the historical target movement amount corresponding to the previous movement stroke as the target movement amount if the size difference between the first spot size and the second spot size is less than or equal to the preset size difference;
a sub-module for determining the target movement amount according to the size difference if the size difference between the first spot size and the second spot size is greater than the preset size difference;
a module for obtaining the focusing center position information corresponding to the laser focusing element in the laser to be detected;
a module for determining the main optical axis position information of the laser focusing element according to the focusing center position information and the position information of the detection platform that carries the laser to be detected;
a module for controlling the position adjustment of the detection head of the spot analyzer according to the main optical axis position information, so that the center point of the detection head of the spot analyzer is located on the main optical axis.

8. The spot detection control device according to claim 7, wherein the sub-module for determining the target movement axis of the detection head of the spot analyzer according to the size relationship between the first spot size and the second spot size comprises:
a sub-module for determining the second axis as the target movement axis if the first spot size is less than or equal to the second spot size, and the movement axis of the previous movement is the first axis; and
a sub-module for determining the second axis as the target movement axis if the first spot size is larger than the second spot size.

9. The spot detection control device according to claim 7, wherein the first spot information comprises spot size and spot intensity data;
the module for determining the spot detection result of the laser device based on the first spot information collected by the spot analyzer at the focal position comprises:
a sub-module for obtaining the spot size and spot intensity data collected by the spot analyzer corresponding to the focal position; and
a sub-module for determining that the spot detection result is qualified if the spot size is the same as the standard reference spot size corresponding to the focal point of the laser device, and the spot intensity data falls within the standard intensity data range corresponding to the focal point of the laser device.

10. The spot detection control device according to claim 7, further comprising:
a module for obtaining spot threshold information corresponding to the laser to be detected, where the spot threshold information comprises at least one of a maximum spot size, a spot shape similarity threshold, and a maximum spot intensity range;
a module for controlling the detection head of the spot analyzer to move along the first axis starting from the focal position, and collecting second spot information in real time;
a module for controlling the detection head of the spot analyzer to move along the second axis starting from the focal position, and collecting third spot information in real time;
a module for determining the defocus error threshold of the laser according to the matching degree between the second spot information, the third spot information, and the spot threshold information respectively.

11. The spot detection control device according to claim 8, further comprising:
a module for obtaining spot threshold information corresponding to the laser to be detected, where the spot threshold information comprises at least one of a maximum spot size, a spot shape similarity threshold, and a maximum spot intensity range;
a module for controlling the detection head of the spot analyzer to move along the first axis starting from the focal position, and collecting second spot information in real time;
a module for controlling the detection head of the spot analyzer to move along the second axis starting from the focal position, and collecting third spot information in real time;
a module for determining the defocus error threshold of the laser according to the matching degree between the second spot information, the third spot information, and the spot threshold information respectively.

12. The spot detection control device according to claim 9, further comprising:
a module for obtaining spot threshold information corresponding to the laser to be detected, where the spot threshold information comprises at least one of a maximum spot size, a spot shape similarity threshold, and a maximum spot intensity range;
a module for controlling the detection head of the spot analyzer to move along the first axis starting from the focal position, and collecting second spot information in real time;
a module for controlling the detection head of the spot analyzer to move along the second axis starting from the focal position, and collecting third spot information in real time;
a module for determining the defocus error threshold of the laser according to the matching degree between the second spot information, the third spot information, and the spot threshold information respectively.

13. A spot detection control method, comprising:
controlling a spot analyzer to move to a focal position on the main optical axis according to the change information among the laser spot sizes corresponding to different positions on the main optical axis when the laser emitted by the laser device to be detected is transmitted to the different positions; and
determining the spot detection result of the laser device based on the first spot information collected by the spot analyzer at the focal position, wherein the first spot information comprises at least one of spot size, spot shape, and spot intensity data;
wherein controlling a spot analyzer to move to a focal position on the main optical axis according to the change information among the laser spot sizes corresponding to different positions on the main optical axis comprises:
controlling the detection head of the spot analyzer to move axially corresponding to the main optical axis, and obtaining the first spot size collected by the spot analyzer before movement and the second spot size re-collected by the spot analyzer after movement;
determining target movement information for the next movement of the spot analyzer according to the change information between the first spot size and the second spot size;
controlling the detection head of the spot analyzer to move axially corresponding to the main optical axis based on the target movement information until the re-collected spot size after movement is the smallest; and
taking the collection position corresponding to the smallest spot size as the focal position;
wherein determining target movement information for the next movement of the spot analyzer according to the change information between the first spot size and the second spot size comprises:
determining the target movement axis of the detection head of the spot analyzer according to the size relationship between the first spot size and the second spot size, where the target movement axis is either the first axis or the second axis corresponding to the main optical axis, and the first axis is opposite to the second axis; and
determining the target movement amount according to the size difference between the first spot size and the second spot size;
wherein the target movement axis and the target movement amount are the target movement information;
wherein determining the target movement axis of the detection head of the spot analyzer according to the size relationship between the first spot size and the second spot size comprises:
If the first spot size is less than or equal to the second spot size, and the movement axis of the previous movement is the first axis, determining the second axis as the target movement axis; and
If the first spot size is larger than the second spot size, determining the second axis as the target movement axis.

14. The spot detection control method according to claim 13, wherein determining the target movement amount according to the size difference between the first spot size and the second spot size comprises:
if the size difference between the first spot size and the second spot size is less than or equal to a preset size difference, taking half of the historical target movement amount corresponding to the previous movement as the target movement amount; and
if the size difference between the first spot size and the second spot size is larger than the preset size difference, determining the target movement amount according to the size difference.

15. The spot detection control method according to claim 13, wherein before controlling the spot analyzer to move to the focal position on the main optical axis according to the change information among the laser spot sizes corresponding to different positions on the main optical axis, the method further comprises:
obtaining the focusing center position information corresponding to the focusing element in the laser to be detected;
determining the main optical axis position information of the focusing element according to the focusing center position information and the position information of the detection platform that carries the laser device to be detected; and
controlling the position adjustment of the detection head of the spot analyzer according to position information of the main optical axis, so that the center point of the detection head of the spot analyzer is located on the main optical axis.

16. The spot detection control method according to claim 13, wherein the first spot information comprises spot size and spot intensity data;
Wherein determining the spot detection result of the laser device based on the first spot information collected by the spot analyzer corresponding to the focal position comprising:
obtaining the spot size and spot intensity data collected by the spot analyzer corresponding to the focal position; and
if the spot size is the same as the standard reference spot size corresponding to the focal point of the laser device, and the spot intensity data falls within the standard intensity data range corresponding to the focal point of the laser device, determining that the spot detection result is qualified.

17. The spot detection control method according to claim 13, characterized by further comprising:
obtaining spot threshold information corresponding to the laser to be detected, where the spot threshold information comprises at least one of a maximum spot size, a spot shape similarity threshold, and a maximum spot intensity range;
controlling the detection head of the spot analyzer to move along the first axis starting from the focal position, and collecting second spot information in real time;
controlling the detection head of the spot analyzer to move along the second axis starting from the focal position, and collecting third spot information in real time;
determining the defocus error threshold of the laser according to the matching degree between the second spot information, the third spot information, and the spot threshold information respectively.

18. The spot detection control method according to claim 14, further comprising:
obtaining spot threshold information corresponding to the laser to be detected, where the spot threshold information comprises at least one of a maximum spot size, a spot shape similarity threshold, and a maximum spot intensity range;
controlling the detection head of the spot analyzer to move along the first axis starting from the focal position, and collecting second spot information in real time;
controlling the detection head of the spot analyzer to move along the second axis starting from the focal position, and collecting third spot information in real time; and
determining the defocus error threshold of the laser according to the matching degree between the second spot information, the third spot information, and the spot threshold information respectively.

19. The spot detection control method according to claim 15, further comprising:
obtaining spot threshold information corresponding to the laser to be detected, where the spot threshold information comprises at least one of a maximum spot size, a spot shape similarity threshold, and a maximum spot intensity range;
controlling the detection head of the spot analyzer to move along the first axis starting from the focal position, and collecting second spot information in real time; and
controlling the detection head of the spot analyzer to move along the second axis starting from the focal position, and collecting third spot information in real time;
determining the defocus error threshold of the laser according to the matching degree between the second spot information, the third spot information, and the spot threshold information respectively.

20. The spot detection control method according to claim 16, further comprising:
obtaining spot threshold information corresponding to the laser to be detected, where the spot threshold information comprises at least one of a maximum spot size, a spot shape similarity threshold, and a maximum spot intensity range;
controlling the detection head of the spot analyzer to move along the first axis starting from the focal position, and collecting second spot information in real time;
controlling the detection head of the spot analyzer to move along the second axis starting from the focal position, and collecting third spot information in real time; and
determining the defocus error threshold of the laser according to the matching degree between the second spot information, the third spot information, and the spot threshold information respectively.
